(19) United States
(12) Patent Application Publication
(10) Pub. No.: US 2009/0145942 A1
(43) Pub. Date: Jun. 11, 2009

(54) Water Bottle Cage Mounted Container

(76) Inventor: Glenn Stephen Rice, (US)

Correspondence Address: Glenn Rice, 2911 Sycamore Springs Drive Apt. 102, Kingwood, TX, 77339, US

(21) Appl. No.: 12/276,340

(22) Filed: Nov. 23, 2008

Related U.S. Application Data
(60) Provisional application No. 61/005,484, filed on Dec. 5, 2007.

(51) Int. Cl. B62J 9/00

(52) U.S. Cl. 224/419; 224/463

(57) ABSTRACT

A container mounted on a standard bicycle water bottle cage. The container could be a fabric bag or a hard shell case. In the preferred embodiment the container is fastened to the bottle cage by a plurality of straps, with at least one upper strap oriented to wrap around the curved upper front portion of the bottle cage and at least two lower straps, each oriented to wrap around each opposing vertical leg of the bottle cage. These straps can be attached to the container or attached to a base plate that is designed to receive the container.

### CROSS-REFERENCE TO RELATED APPLICATIONS

This patent claims benefit of Provisional Patent 61/005,484.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF INVENTION

1. Field of Invention

This invention relates to bicycle accessories such as small packs or bags and also accessories that utilize water bottle cages, such as storage containers, lighting batteries, and audio devices.

2. Prior Art

Cyclists often need or prefer to carry various items while riding, such as repair kits, wallet, keys, cell phone, snacks, etc. The most popular way to carry these items is a seat bag. This is a bag that fits underneath the seat of the bicycle. However many cyclist use water bottle cage holders mounted behind the seat. Some of these holders are attached to the rails underneath the saddle, others are clamped around the seat post. These behind the seat water bottle cage holders can make seat bags difficult to install and access. Another drawback of seats bags is that their location requires that the bag be accessed from the side or end, allowing items to fall out when the bag is opened.

Others ways cyclist carry items is the use of a frame and stem bags. Frame bags are triangular shaped bags that fit inside the main triangle of the bicycle. The drawback to these bags is that they eliminate or hinder the use of water bottle cages. They also prevent a frame pump from being carried below the top tube. Stem bags are secured to the bikes top tube and handlebar stem Both of these bags are attached with straps, usually hook and loop, that wrap around the frame. These straps, over time, can abrade the frames finish.

Another method of carrying items is to utilize water bottle cages. Although bottle cages come in many styles, the most common type of bottle cage is the traditional or standard water bottle cage. This can be described as a hoop of metal rod, part of which is bent into a narrow inverted U shape to which a metal plate with holes is attached forming a base plate for mounting the bottle cage on the bike frame. The open end of the inverted U shape is bent for a short distance at a right angle to the base, with the rods diverging, to form the bottom of the bottle cage. The remaining sections of the rods are then bent back slightly towards the base to form two vertical legs. The span between these legs is bent to form a curved upper front portion that matches the circumference of the water bottle. Similarly styled cages can be made of plastic.

Accessories that utilize existing water bottle cages are designed to fit inside the cage. Bicycle lighting companies have long used batteries that are shaped like water bottles. There are also storage container, tool kits and radios that are shaped to fit inside water bottle cages. While this method provides a convenient way of mounting an accessory on a bicycle, it has a major drawback in that it eliminates the use of the water bottle cage to carry a water bottle. If the cyclist uses these accessories they must either carry less water or add additional bottle cages. These accessories are also limited to a more or less cylindrical shape, and must be of a diameter that fits inside the bottle cage.

U.S. Pat. Nos. 5,170,981 and 5,217,116 are bottle cages with storage pods attached to their bases. These are propriety designs that cannot retro-fitted to existing cages. The location of the storage pods under the water bottle cage severely limits their capacity, especially when used inside the bicycle frame.

What is needed is a way to utilize standard bicycle water bottle cages for storage containers and other accessories without displacing the water bottle.

### SUMMARY OF INVENTION

The main object of the present invention is a container that utilizes an existing standard water bottle cage without displacing the water bottle.

Another object of the present invention is a container that utilizes an existing standard water bottle cage that is not limited in its size or shape by the internal dimensions of the bottle cage.

Another object of the present invention is a container in that provides more accessible storage.

Another object of the invention is a container that does not attach to the bicycles frame, eliminating wear to the frames finish.

These objects can be met by fastening a container to the curved upper front portion and the front vertical legs of a standard bicycle water bottle cage. To my knowledge, no storage container or any other accessory has ever been attached to a bicycle water bottle cage in this manner.

### DESCRIPTION OF DRAWINGS

FIG. 1 is a side rear perspective of the invention attached to a water bottle cage

FIG. 2 side rear perspective view of the invention

FIG. 3 is a rear side perspective of an alternate version of the invention attached to a water bottle cage

FIG. 4 is a rear side exploded view alternate version of the invention

FIG. 5 is a rear side perspective view and another alternate embodiment of the invention

### DETAILED DESCRIPTION OF DRAWINGS

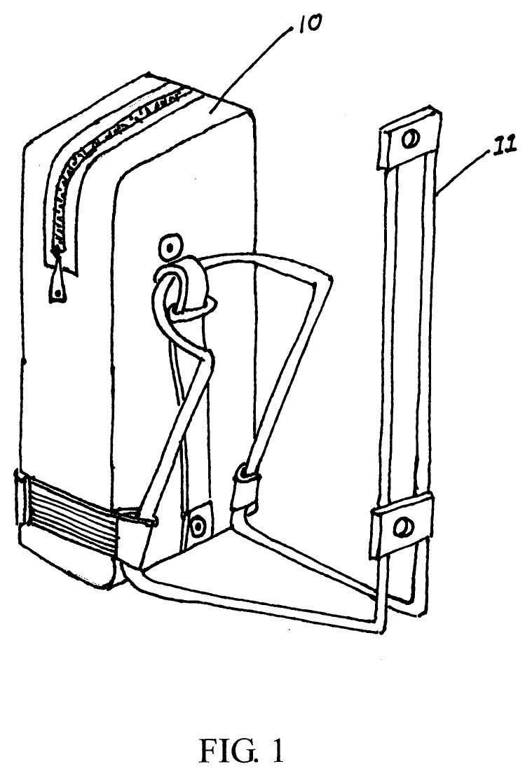

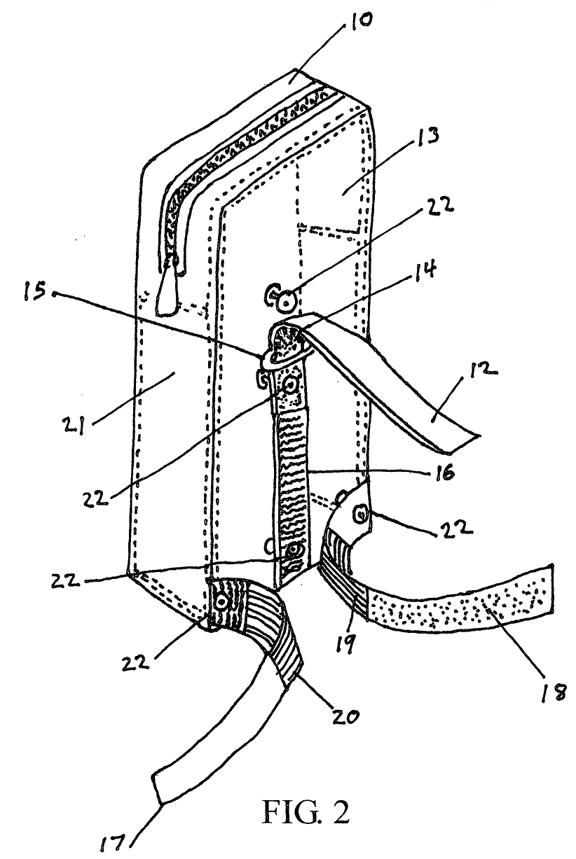

One embodiment of the invention is shown in FIG. 1 and FIG. 2, in which 10 is a container. While the container 10 could take many forms, in the drawings it is a fabric bag that is rectangular cube shaped enclosing a space and has a zippered opening on its upper surface. The container 10 could have other features common of bicycle bags, external pockets, reflective tape, webbing for attaching lights, etc. It is preferable that the container be of a size that the rear wall contacts the front upper curved portion and the bottom of the front legs of the water bottle cage 11. FIG. 1 shows the container 10 attached to a water bottle cage 11.

Referring to FIG. 1 the container 10 is fastened to the water bottle cage 11 by a plurality of straps, attached to the water bottle cage, having at least one upper strap which is oriented to fasten to the curved upper front curved portion of the bottle cage 11, and a least two lower straps, each of which fastens to an opposing front vertical leg of the bottle cage 11. In the embodiment in FIGS. 1 and 2 the straps are hook and loop material.

Referring to FIG. 2, an upper strap 12, which in the drawing is of loop material, wraps around the curved upper front portion of the water bottle cage 11 and supports the upper part of the container 10. One end of this strap 12 is attached centrally on the rear wall 13 of the container 10, and is oriented vertically. It is preferable that the rear wall of the container contact the front upper curved portion of the water bottle cage. This will prevent the container 10 from slipping under the front upper curved portion of the water bottle cage 11 and blocking the insertion of the water bottle. A section of rubber 14 or similar material is attached to the inner part of strap 12 that wraps around the front curved upper front portion of the water bottle cage 11. This helps to minimize lateral movement of the strap 12.

It is preferable that a ring 15, is attached to the rear wall 13 of container 10 at the point where strap 12 is attached to the rear wall 13 of the container 10. This ring 15 helps to draw the strap 12 tight against the curved upper portion of the water bottle cage.

After wrapping around the curved upper front portion of the water bottle cage 11, strap 12 is feed thru the ring 15 and attached to a corresponding section of hook material 16 attached to the rear wall 13 of the container 10.

Two lower straps 17, 18 are attached, one on each side, towards the bottom of the container 10 and support the lower part of the container 10. These straps 17,18 are oriented to wrap around and behind the front vertical legs of the water bottle cage 11, around the sides of the container 10 and across the front of the container 10. In the drawing the straps 17,18 are alternately hook and loop material and are oriented to fasten to each other across the front of the water bottle cage. They prevent the container from tipping over and blocking the opening of the water bottle cage 11 and reduce lateral movement of the bottom of container 10. In the embodiment shown these straps 17,18 are attached to the rear wall 13 of the container. It is preferable that these straps 17,18 should be located so that they wrap around near the bottom of the front vertical legs of the water bottle cage, when strap 12 is attached to the curved upper front portion of the water bottle cage. It is preferable that the lower part of rear wall 13 of the container 10 be as wide or wider than the span of the lower front vertical legs to allow the point of attachment of each strap 17,18 to be near each front vertical leg of the water bottle cage 11, to allow the strap to wrap as tightly as possible around the leg. If the attachment point is to far inside of the front vertical legs of the water bottle cage 11, the water bottle may snag on straps 17,18 during insertion. If the lower part of the container 10 is fastened tightly to the water bottle cage before the water bottle is inserted, it is possible that the curved upper portion front portion of the water bottle cage may bend excessively outward when the water bottle contacts the container, causing the water bottle to be loose in the cage 11. It is therefore preferably that straps 17,18 contain a section of elastic material 19,20. This allows the straps 17,18 to fastened without slack in them to an empty bottle cage. When the bottle is inserted, this elastic material 19,20, will allow the lower part of the container 10 to move outward.

It is preferable in the case of a fabric container, that certain parts of the rear wall 13 are attached to a rigid or semi-rigid piece material to reduce distortion of the bag when tension is applied to the straps 12,17 and 18. In FIG. 2 this piece of rigid or semi-rigid material forms an insert 21 located inside the container 10. This insert 21 should be approximately the height and width of the rear wall 13 of the container. 10 In the embodiment shown, rivets 22, are used to attach parts of the rear wall 13 and straps 12,17 and 18 to the insert 21 at locations where there is stress when tension is applied to the straps 12,17 and 18. These locations are where straps 17,18 are attached, the attachment point of strap 12 below the rectangular ring 14, above the attachment point of strap 12 and at the bottom of the section of hook material 15. Other methods of fastening the rear wall 13 and the straps 12,17 and 18 to the insert 21 could used, such as adhesives, sewing, etc. In the case of a fabric container, the rigid or semi-rigid piece of material could also be attached to the outside of the container to form a backing, with straps 12,17 and 18 attached directly to this backing.

If the lower straps 17,18 are to be wrapped around a fabric container as shown in FIGS. 1 and 2, it is preferable that a means be provided to reduce the amount the container 10 collapses when the lower straps 17,18 and fastened across the front of the container 10. In the embodiment shown this is accomplished by making the insert 21, channel shaped below the starting point of the zipper. This makes the insertion and removal of items easier. It also helps prevent the lower straps 17,18 from slipping off the container 10 when they are attached close to the bottom of the container 10.

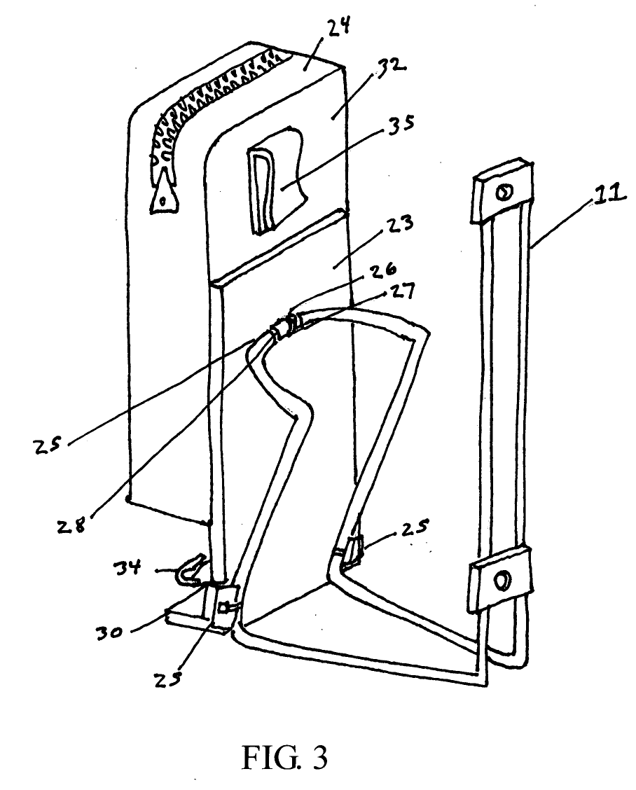

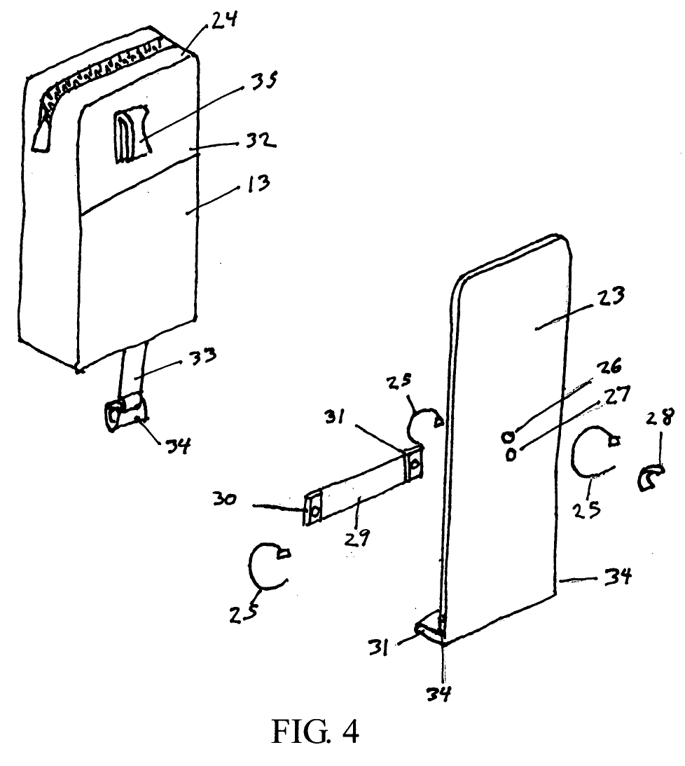

An alternate embodiment is shown if FIGS. 3 and 4. FIG. 3 shows the embodiment attached to a water bottle cage. FIG. 4 show and exploded view of the embodiment. Here a piece of rigid or semi-rigid material is attached to the front of the water bottle cage 11 forming a base plate 23 to receive a detachable container 24. The base plate 23 in the embodiment is more or less rectangular but other shapes are possible. It is preferable that the base plate 23 be of a size to contact the front upper curved portion and the bottom of the front legs of the bottle cage 11. The base plate 23 could be fastened to the bottle cage by the arrangement of straps described for FIGS. 1 and 2. However since the base plate 23 is a more or less permanent arrangement, the straps in this embodiment consist of an elastic band 29 and zips ties 25.

The upper part of the base plate 23 extends above the curved upper front portion of the bottle cage and is fastened to the bottle cage by a zip tie 25 that wraps around the cage and thru two holes 26,27 which are located above and below the horizontal centerline, at the point where the base plate contacts the curved upper front portion of the bottle cage 11. It is preferable that the span between the two holes 26,27 is be slightly smaller than the diameter of the rod used in the bottle cage to allow the zip tie 25 to wrap tightly around the curved upper front portion bottle cage 11. To help prevent the zip tie 25 from slipping from side to side, a piece of rubber tape 28 or similar material is wrapped around the front upper curved portion of the bottle cage 11.

Since it is preferable that the lower part of the base plate be able to move outward when a water bottle is inserted to prevent excessive bending of the bottle cage, the zip ties 25 that wrap around the front legs are not attached directly to the base plate 23. These zip ties 25 are instead attached to a band 29 of elastic material, with holes 30,31 at each end, that stretches across the front and around the sides of the base plate 23 and attached with zip ties 25 to the front vertical legs of the water bottle cage. The ends of the elastic band 29 should be reinforced, such as folding the material upon itself and attaching eyelets for the holes. End tips of rigid material with holes them could also be attached to the ends of the band 29. In this embodiment it is also preferable that the lower part of the base plate 23 be as wide or wider than the span of the bottom of the front legs, to allow the elastic band 29 to hold the base plate against the water bottle cage 11 when the cage is empty, to minimize movement of the base plate 23. A zip tie 25 is passed thru one of these holes 30,31 and around a front vertical leg of the bottle cage 11. The elastic band 29 is then stretched across the front of the base plate and attached in the same manner with a zip tie 25, to the opposing front vertical leg of the bottle cage 11. It is preferable that the area 34 the elastic band 29 contacts on the side of base plate 23 be will rounded to help prevent chaffing of the elastic band 29. A lip 31 on the bottom of the base plate 23 prevents the elastic band 29 from slipping off.

In the embodiment shown the base plate extends well above the curved upper front portion of the bottle cage. A container 24 has a sleeve 32 on its rear wall 13 that slides over the upper part of the base plate 23. It is preferable that the rear wall of container 24 have a rigid or semi-rigid insert to allow the container 24 to mate more evenly with the base plate 23. A strap 33 is attached to the bottom of the container with a hook 34 at the lower end of the strap 33. When the container is installed on the base plate 23 this strap 33 and hook 34 are passed under the elastic band 29. Should the bag try to slip off the base plate 23 the hook 34 will catch the elastic band 29 and help prevent the container 24 from coming loose. The embodiment shown has a belt clip 35 attached to the outside of the sleeve, to facilitate carrying the container when off the water bottle cage 11. Other methods of detachably mounting the container 24, or other accessories to base plate 23 could also be used. For example, quick release devices for seat bags are well known and these could be adapted to the base plate 23.

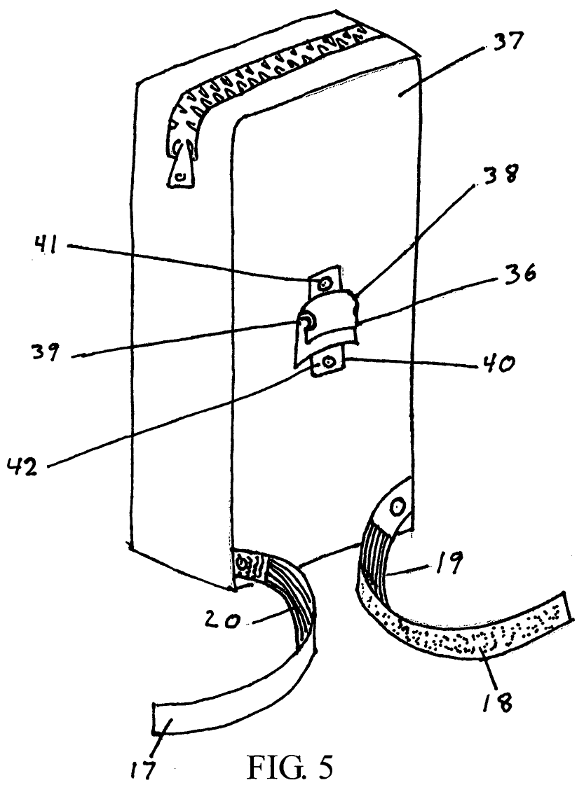

Another alternate embodiment is shown in FIG. 5. This embodiment uses an inverted U shaped clip 36 to attach the container 37 to curved upper front portion of the water bottle cage 11. This clip 36 is curved and has a radius approximate that of the curved upper portion of water bottle cage the 11. The clip 36 is narrower than the rod used in the cage except for the uppermost portion of the closed end 38 of the clip which is enlarged to a diameter slightly larger than the diameter of the rod used in the bottle cage. This enlarged end is lined with rubber 39 or similar material to help prevent lateral movement of the clip. The clip has an integral flat base 40 that is attached to the container with rivets 41,42. The lower part of the container 36 is supported by straps as described for FIGS. 1 and 2.

In view of the preceding detailed description, many changes and variations will be apparent to those skilled in the art without departing from the spirit and scope of the invention. The container 10, for instance could be a hard shell case for storing items or the housing for a battery. The base plate 23 could be used for detachably mounting other accessories.

1. What I claim is a container that fastens to a standard bicycle water bottle cage comprising of:
a plurality of straps, having at least one upper strap which is oriented to fasten to the curved upper front curved portion of the said bicycle water bottle cage, and a least two lower straps, each of which fastens to an opposing front vertical leg of the said bicycle water bottle cage

2. What I claim is a base plate and container that attaches to the front of a standard water bottle cage comprising of:
said base plate made of rigid or semi rigid material, with a plurality of straps attached to said base plate, having at least one upper strap which is oriented to fasten to the curved upper front curved portion of said bicycle water bottle cage, and a least two lower straps, each of which fastens to an opposing front vertical leg of the said bicycle water bottle cage, with a means to detachable mount said container to said base plate.

3. What I claim is a container that attaches to the front of a standard water bottle cage comprising of
an curved inverted U shaped clip attached to said container that engages the curved upper front portion of said water bottle cage, and a least two lower straps, each of which fastens to an opposing front vertical leg of the said bicycle water bottle cage
